(19) United States
(12) Patent Application Publication
(10) Pub. No.: US 2019/0007884 A1
(43) Pub. Date: Jan. 3, 2019

(54) CELL SELECTION FOR EXCEPTION REPORTING FOR WIRELESS NETWORKS

(71) Applicant: NOKIA SOLUTIONS AND NETWORKS OY, Espoo (FI)

(72) Inventors: Jussi-Pekka Koskinen, Oulu (FI); Jorma Johannes Kaikkonen, Oulu (FI); Lars Dalsgaard, Oulu (FI)

(21) Appl. No.: 16/069,114

(22) PCT Filed: Jan. 12, 2016
(86) PCT No.: PCT/EP2016/050459

§ 371 Date: Jul. 10, 2018

(51) Int. Cl. H04W 36/30; H04W 36/38; H04W 28/20; H04W 64/00; H04W 36/00; H04W 36/08; H04W 48/20

(52) U.S. Cl. CPC H04W 36/30; H04W 36/38; H04W 28/20; H04W 72/0453; H04W 36/0085; H04W 36/08; H04W 48/20; H04W 64/006

(57) ABSTRACT

A technique is provided for selecting a cell in a wireless network to send a report, the technique including: selecting, by a user device, a cell based on different cell selection criteria for different reporting, including: selecting, by the user device based on a first cell selection criteria, a cell to perform normal reporting; and selecting, by the user device based on a second cell selection criteria that is different from the first cell selection criteria, a cell to perform exception reporting; and sending, by the user device via the selected cell, a report including either a normal report or an exception report.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, above 6 GHz. For fifth generation wireless systems (5G), an access architecture for deployment of cellular radio equipment employing mmWave radio spectrum has been proposed. Other example spectrums may also be used, such as cmWave radio spectrum (3-30 GHz).

In addition, Internet of Things (IoT) may refer to an ever-growing group of objects that may have Internet or network connectivity, so that these objects may send information to and/or receive information from other network devices.

### SUMMARY

According to an example implementation, a method of selecting a cell in a wireless network to send a report includes: selecting, by a user device, a cell based on different cell selection criteria for different reporting, including: selecting, by the user device based on a first cell selection criteria, a cell to perform normal reporting; and selecting, by the user device based on a second cell selection criteria that is different from the first cell selection criteria, a cell to perform exception reporting; and sending, by the user device via the selected cell, a report including either a normal report or an exception report.

According to an example implementation, an apparatus includes at least one processor and at least one memory including computer instructions, when executed by the at least one processor, cause the apparatus to: select, by a user device, a cell based on different cell selection criteria for different reporting, including: select, by the user device based on a first cell selection criteria, a cell to perform normal reporting; and select, by the user device based on a second cell selection criteria that is different from the first cell selection criteria, a cell to perform exception reporting; and send, by the user device via the selected cell, a report including either a normal report or an exception report.

According to an example implementation, an apparatus includes means for selecting, by a user device, a cell based on different cell selection criteria for different reporting, including: means for selecting, by the user device based on a first cell selection criteria, a cell to perform normal reporting; and means for selecting, by the user device based on a second cell selection criteria that is different from the first cell selection criteria, a cell to perform exception reporting; and means for sending, by the user device via the selected cell, a report including either a normal report or an exception report.

According to an example implementation, a computer program product includes a computer-readable storage medium and storing executable code that, when executed by at least one data processing apparatus, is configured to cause the at least one data processing apparatus to perform a method including: selecting, by a user device, a cell based on different cell selection criteria for different reporting, including: selecting, by the user device based on a first cell selection criteria, a cell to perform normal reporting; and selecting, by the user device based on a second cell selection criteria that is different from the first cell selection criteria, a cell to perform exception reporting; and sending, by the user device via the selected cell, a report including either a normal report or an exception report.

According to an example implementation, a method may include determining, by a base station, different cell selection criteria for different reporting, including: a first cell selection criteria to perform normal reporting; and a second cell selection criteria that is different from the first cell selection criteria to perform exception reporting; and sending, by the base station to a user device, the first cell selection criteria and the second cell selection criteria.

According to an example implementation, an apparatus includes at least one processor and at least one memory including computer instructions, when executed by the at least one processor, cause the apparatus to: determine, by a base station, different cell selection criteria for different reporting, including: a first cell selection criteria to perform normal reporting; and a second cell selection criteria that is different from the first cell selection criteria to perform exception reporting; and send, by the base station to a user device, the first cell selection criteria and the second cell selection criteria.

According to an example implementation, an apparatus includes means for determining, by a base station, different cell selection criteria for different reporting, including: a first cell selection criteria to perform normal reporting; and a second cell selection criteria that is different from the first cell selection criteria to perform exception reporting; and means for sending, by the base station to a user device, the first cell selection criteria and the second cell selection criteria.

According to an example implementation, a computer program product includes a computer-readable storage medium and storing executable code that, when executed by at least one data processing apparatus, is configured to cause the at least one data processing apparatus to perform a method including: determining, by a base station, different cell selection criteria for different reporting, including: a first cell selection criteria to perform normal reporting; and a second cell selection criteria that is different from the first cell selection criteria to perform exception reporting; and sending, by the base station to a user device, the first cell selection criteria and the second cell selection criteria.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a flow chart illustrating operation of a user device according to an example implementation.

FIG. 3 is a flow chart illustrating operation of a base station according to an example implementation.

FIG. 4 is a block diagram of a node or wireless station (e.g., base station/access point or mobile station/user device/UE) according to an example implementation.

### DETAILED DESCRIPTION

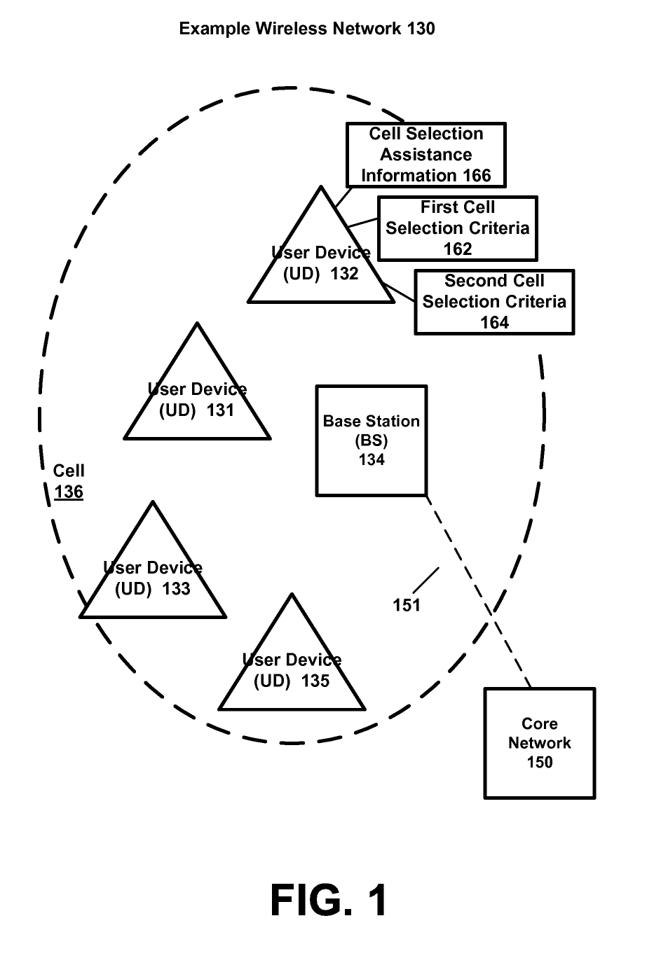

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB) or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, cmWave, and/or mmWave band networks, or any other wireless network. LTE, 5G, cmWave and mmWave band networks are provided only as illustrative examples, and the various example implementations may be applied to any wireless technology/wireless network.

For example, in an illustrative implementation, the various techniques or implementations described herein may be applied to Internet of Things (IoT) devices/user devices, such as narrowband (NB) IoT devices. IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs.

For example, many different types of sensors may be expected to detect or measure event(s) (e.g., occurrence of an event, such as a status, a condition or other occurrence), and then send a report to another network device communicating the event(s), and/or send a report(s) to report information. Some example IoT devices may include smoke alarms (or smoke detectors), car alarms, smart meters or utility meters (e.g., measuring gas, water electricity usage) that may measure usage of a resource or utility (e.g., measuring and reporting utility usage), smart environment meters, smart agriculture meters (e.g., that may measure amount of rainfall in a particular location on a crop field or a condition of soil, and send a report on a daily basis with such status, or send a report when a specific status or event occurs with respect to the soil or crop), etc. IoT devices can be applied to nearly any device, application or situation where it may be useful to track or report conditions or events, and/or control such devices or applications.

For example, an inexpensive tracking device, e.g., including a GPS (global positioning system) receiver (to determine the package's location) and a wireless transceiver (to transmit and send messages over a network), may be placed on each package before it is shipped, and the device may periodically send reports that indicate the package's location. Other example IoT devices may include, for example, thermostats, electronic appliances, speaker systems, vending machines, cash dispensing machines/automatic teller machines, video surveillance cameras, smart vehicles, personal health monitoring devices, etc.

As noted, various user devices (e.g., IoT devices) may detect various events (e.g., including conditions, status, occurrences . . . ), and the user device may then send a report to another network device that includes information regarding (e.g., describing) the event. These events, and the reports (e.g., electronic messages) that communicate information related to such events may be provided in at least two categories, for example: normal events reported via a normal report, and exception events reported via exception reports.

According to an example implementation, normal events may include, for example, low priority and/or medium and/or normal priority events, and may include events that would typically or normally occur or be detected, e.g., on a frequent basis and/or during the normal operation or course of operation of a sensor or other device, and/or events that may not be considered extraordinary. As some illustrative examples, normal events may include: a user device on a package periodically reporting its location to a network device; a smoke alarm or car alarm detecting that the alarm is operating correctly (e.g., passed a built-in self test) and the battery is providing sufficient voltage/current, and then sending a status report every day indicating that the alarm is operational; a wireless/user device connected to a utility meter measuring utility usage for a time period (e.g., day, week), and sending a utility usage report (e.g., electricity consumption report) to a network device associated with the utility provider. Because the normal events may typically be low or medium priority, it is typically not required to immediately report the normal event (e.g., within some small time period after detecting the normal event). Thus, an electricity consumption report is not typically urgent and may be sent an hour or two (or longer) after the electricity consumption for the previous day or week has been calculated.

On the other hand, exception events may include, for example, high priority events (having a higher priority than normal events) and which may typically occur less frequently than normal events, and may include events of an urgent nature or high (or at least higher) priority, e.g., where there may a need or an advantage to send an exception report (reporting the exception event) within some maximum time period (e.g., within 10 seconds) after detection of the exception event. Typically, it may be important to perform exception reporting within a very limited amount of time (e.g., 5 seconds, 10 seconds, 15 seconds) after detection of the exception event because there is typically some urgent action that should be performed immediately in response to the exception event (e.g., notify the police in response to a house alarm that has been activated so that a police officer may be sent to the house, notify the fire department in response to a smoke detector detecting smoke or fire in a house so that a fire truck can be dispatched to the house, etc.)

Some examples of an exception (or exceptional) event and exception report may include, by way of illustrative example: a utility meter detecting that the utility meter has been tampered with (e.g., to avoid reporting or to cause an incorrect reporting of utility usage) and then the user/wireless device connected to the utility meter sending a tampering report to a network device; a car alarm detecting a break-in or triggering of the car alarm, and the user/wireless device associated with the car alarm then sending an alarm notification report to the owner's cell phone or to a network device for a security monitoring company; a smoke alarm detecting smoke/fire or triggering of the smoke alarm, and the user/wireless device associated with the smoke alarm then sending an alarm notification report to the owner's cell phone and/or to a network device for a security monitoring company, the fire department, etc. These are merely a few examples of exception (or exceptional/high priority) events and associated exception reports that may be sent, such as by IoT devices or other wireless/user devices. As noted, time may be of the essence when reporting an exception event via an exception report, e.g., due to the urgency or priority of the exception event and/or a need for a quick or immediate response to the exception event.

In addition, battery saving has been an important issue for wireless devices. Techniques have been implemented to improve battery life/conserve battery power in wireless devices. One example mechanism that has been used to improve battery life is discontinuous reception (DRX). In DRX, the user device decreases the amount of time spent monitoring a downlink control channel for data. In DRX, the user device and the network negotiate phases in which data transfer occurs. During other times, the user device turns its receiver off and enters a low power state to conserve battery power. A DRX cycle or extended DRX cycle may last 4 hours or more.

According to an illustrative example implementation, when a user device is in an active (or wake) state, the user device may perform cell selection or reselection, which may include, for example, one or more (or even all) of the following operations: scan/detect, measurement, evaluate/suitability check and connection establishment:

Scan/Detect: In an example scan operation, the user device performs a process of repeatedly tuning to each of many carrier frequencies, and measuring/determining a received cell detection signal for each of these carrier frequencies, to identify a subset of carrier frequencies having a highest RSRP and/or RSRQ and/or RSSI (e.g., a set of carrier frequencies having a RSRP greater than a threshold). This process can be a consuming, since there may be many (e.g., 200-300) possible carrier frequencies, for example, that the user device may scan, detect and measure RSRP, to determine a subset of carrier frequencies to perform the next steps of measurement, evaluate and detect. Each cell may have one or more carrier frequencies to be scanned and measured.

Measurement: In an example measurement operation, after a subset of carrier frequencies have been identified in the scan operation (e.g., based on RSRP), the user device may then measure or determine a reference signal received power (RSRP) and/or a reference signal received quality (RSRQ) for each of these carrier frequencies (within the subset of carrier frequencies). According to an illustrative example implementation, RSSI may measure the average total received power observed in reference symbols for antenna port 0 over N resource blocks. RSRP may be a linear average over power contributions of resource elements that carry cell-specific reference signals within a measurement frequency bandwidth. RSRQ may be a ratio of N*RSRP/RSSI, where N is a number of resource blocks for carrier RSSI measurement bandwidth. The measurement operation can also be time consuming for a user device.

Evaluate/Suitability check: In an example evaluate operation, the user device may evaluate or compare the measured carrier signals (e.g., RSSI, RSRP and/or RSRQ, or a value based on one or more of these measurements) to a cell selection criteria, which may include one or more threshold(s), for example, to find a suitable cell/carrier frequency. In an illustrative example implementation, a cell selection criteria may define a threshold RSRP or a threshold RSRQ, where a suitable cell/carrier frequency should have a RSRP/RSRQ that is greater than such threshold of the cell selection criteria. If a cell/carrier frequency has a RSRP or RSRQ (for example) that is greater than this threshold, then the user device may select the cell/carrier frequency to camp on in an idle (e.g., RRC_Idle) state, so that the user device may then receive system information (in the detect operation below), may receive a paging message on this cell if there is a call for the user device, and/or may establish a connection to such cell via random access procedure (moving the user device from idle/RRC_Idle state to a connected/RRC_Connected state with respect to the selected cell to allow the user device to send information to such cell).

Connection Establishment: In an example detect operation, the user device may tune its receiver to a downlink control channel of the selected cell/selected carrier frequency (of the cell that met the cell selection criteria) to receive system information for the cell to determine, for example, cell identity, a transmission mode and other system parameters for the cell. After obtaining system information for the selected suitable cell that met the cell selection criteria, the user device may then perform random access with the selected cell (e.g., by sending a connection request/random access request to the cell/BS) in order to establish a connection with the selected cell. After a user device is connected to a cell, the user device may request and obtain uplink resources to allow the user device to transmit/send information to the selected cell, for example. In an example implementation, this last operation of connection establishment may not necessarily be considered part of cell selection/reselection, e.g., since the cell selection may, at least in some cases, be considered completed after the evaluate/suitability check has been performed, according to an example implementation. Thus, in an example implementation, the connection establishment operation may be performed after a cell has been selected in order to connect to such selected cell and, e.g., send a report via such selected cell, for example.

The above noted example operation(s) may be used to perform cell selection, but other types of cell selection, which may include same or different operations, may also be used, such as by IoT devices or other devices searching for a cell, selecting a cell, and then communicating with the selected cell/BS using a variety of different operations.

According to an illustrative example implementation, when a user device wakes up from a DRX sleep state, the user device may typically repeat all or part of the above-described example cell selection/reselection process, which may include, for example, one or more (or even all) of scan/detect, measurement, evaluate/suitability check and connection establishment, which may require a significant amount of time. As noted above, a significant delay (e.g., greater than 10 seconds, as an illustrative example) from a detection of an exception event until a sending of an exception report to a cell/BS may not be acceptable for many high priority applications or exception events.

Therefore, according to an example implementation(s), two (or more) example features or example techniques may be used, either separately or in combination, to decrease a delay/latency from detecting an exception event until sending the exception report, including: 1) different cell selection criteria may be used for normal reporting and exception reporting, and 2) providing the user device with cell assistance information to assist the user device with selecting a cell. For example, as shown in FIG. 1, user device 132 may receive (e.g., from BS 134) and/or store in memory: a first cell selection criteria 162 for normal reporting and normal operation; a second cell selection criteria 164 for exception reporting; and, cell selection assistance information 166 to assist the user device with cell selection. The cell selection criteria may also be referred to as cell suitability criteria, suitability criteria, S-criteria, S-criterion, etc.

First, different cell selection criteria may be used for different reporting (e.g., for different types of reporting—normal reporting, and exception reporting). For example, a first cell selection criteria 162 (FIG. 1) may be used to select a cell to perform normal reporting (and normal operation of the user device), and a second cell selection criteria 164 (FIG. 1) may be used to select a cell for exception reporting. For example, the first cell selection criteria 162 may include a first threshold (e.g., a first RSRP threshold or a first RSRQ threshold), while the second cell selection criteria 164 may include a second threshold (e.g., a second RSRP threshold or a second RSRQ threshold), where the first and second thresholds are different. For example, a user device may be provided the first cell selection criteria 162 (e.g., a first threshold), and a second cell selection criteria-offset that indicates the second cell selection criteria as one or more offsets from the first cell selection criteria.

For example, the first threshold for the first cell selection criteria that is used to select a cell for normal user device operation and normal reporting (to report a normal event) may include a RSRP/RSRQ threshold that will ensure (or at least increase the likelihood of a) selection of a cell for a continued operation over a period of time, e.g., to allow the user device to send and/or receive data and signals over a period of time, even as the user device may move within some range/distance (for example, even as the user device may move away from the cell/BS some distance), for example. Thus, according to an example implementation, the user device may camp on a cell that meets the first cell selection criteria 162 used to select a cell for normal operation/normal reporting, for example.

According to an example implementation, a second cell selection criteria 164 may be selected for exception reporting that may be less rigorous or less demanding than the first cell selection criteria 162 used to select a cell for normal operation and/or normal reporting. Thus, for example, the second cell selection criteria 164 for exception reporting may include a second threshold (e.g., a second RSRP/RSRQ threshold) that may be less than the first threshold for the first cell selection criteria 162, for example. With a less demanding/less rigorous criteria for the second cell selection criteria 164 for exception reporting (e.g., a second RSRP/RSRQ threshold for the second cell selection criteria 164 that is less than/lower than the first RSRP/RSRQ threshold for the first cell selection criteria 162), this may allow the user device, after detecting an exception event, to more quickly perform cell selection and then send then send the exception report, as compared to using the (more demanding/more rigorous) first cell selection criteria 162 for normal operation/normal reporting. This is because, for example, the user device may more quickly be able to select a cell that meets the lower second cell selection criteria 164 (or second threshold for exception reporting), since that second threshold may be lower than the first threshold. For example, cells meeting the second threshold for exception reporting may be more plentiful for the user device than cells meeting the more rigorous first threshold for normal operation/normal reporting. Thus, using a second cell selection criteria 164 (second threshold, e.g., lower than the first threshold) that is less demanding than the first threshold may allow a user device, e.g., to more quickly identify and select a cell that meets the second cell selection criteria 164 (e.g., find a cell that may be suitable for the limited purpose of sending an exception report), but which may not meet the more rigorous first cell selection criteria 162 (and thus such cell may not be sufficient for normal operation or normal reporting). Thus, according to an example implementation, it is acceptable to select a cell that does not meet such first cell selection criteria 162, but meets only the less demanding (e.g., lower threshold) second cell selection criteria 164 because of the urgent need/requirement to send the exception report. The cell selection criteria may be previously stored (or stored in advance) by the user device and then retrieved, or may be sent by a BS/cell to the user device, and then stored at the user device.

According to an example implementation, a user device may wake from the DRX sleep state in response to detecting the exception event, and then may select a cell (or carrier) based on the second cell selection criteria 164 for exception reporting, and then may send the exception report to report the exception event. In this example, if the cell selected for exception reporting did not meet the first cell selection criteria 162 for normal operation/normal reporting, then the user device may not camp on such cell or continue connected with such cell.

Thus, in such case, after performing the urgent exception reporting to report the detected exception event to a first cell, the user device may disconnect from the selected first cell (e.g., since such selected first cell only met the less rigorous second cell selection criteria 164, and did not meet the first cell selection criteria 162), and may perform cell selection again based on the first cell selection criteria 162, e.g., including performing one or more (or even all) operations of scan/detect, measurement, evaluate/suitability check and connection establishment, to select a second cell that meets the first cell selection criteria 162 used for normal operation/normal reporting. Because the second cell met or fulfilled the first cell selection criteria 162 for normal operation/normal reporting, the user device may connect to the second cell to send and receive data, and/or may camp on such second cell to receive system information, receive pages from the second cell, etc.

According to an example implementation, if a normal event is detected by a user device or for the user device to perform normal reporting, the user device may, for example, wait for the user device to wake from DRX sleep state, perform cell selection/reselection if necessary based on the first cell selection criteria 162 (for normal reporting), and then send the normal report to report the normal event. Thus, it is acceptable to use the more rigorous first cell selection criteria 162 for normal reporting because it, for example, may typically be less urgent to report a normal event, as compared to reporting an exception event that may be far more urgent/time sensitive.

According to an example implementation, a second cell selection criteria 164 may include no criteria (or no requirements) for selecting a cell for exception reporting. In other words, in an example implementation, the second cell selection criteria 164 may not specify any minimum or threshold RSSI, RSRP, RSRQ, etc., that should be met or fulfilled by a cell before selecting a cell for exception reporting, but rather, in such an example, the user device may be allowed to select any cell to send the exception report (e.g., no minimum signal/power thresholds required for exception reporting in this case). Also, according to an example implementation, a user device may be allowed to select a cell or carrier with any public land mobile network (PLMN)/mobile network to send an exception report (e.g., user device is not merely limited to cells or carriers/carrier frequencies for the PLMN for which the user device has subscribed for exception reporting, e.g., due to the urgency of the exception reporting).

Second, cell selection assistance information 166 may be provided to the user device to assist the user device with selecting a cell, e.g., to assist the user device and thereby likely decrease the delay or time period required for the user device to select a cell for exception reporting. The cell selection assistance information 166 may assist the user device with selecting a cell for exception reporting. The cell selection assistance information 166 may provide the user device with tips, guidance, advice or other information that may facilitate or speed up the cell selection process for the user device. In one example implementation, the cell selection assistance information 166 may be used for normal reporting (or normal operation), and for exception reporting. In another example implementation, the cell selection assistance information 166 may be used by the user device only for selecting a cell for exception reporting. For example, the cell selection assistance information 166 may indicate, e.g., resources, configurations or other parameters where a user device should attempt cell selection, such as where the user device should perform one or more: scan/detect, measure, evaluate/suitability check, connection establishment, etc., in attempt to select a cell for sending a report (e.g., for sending an exception report). To decrease the delay or amount of time to select a cell and send an exception report, the user device may advantageously search for a cell based on or as directed by the cell selection assistance information 166. In an example implementation, the cell selection assistance information 166 may identify resources that may be reserved or made available to user devices for exception reporting. For example, various mobile network operators may reserve specific resources, e.g., carriers, resources, etc., for user devices to send exception reports to a cell.

According to an example implementation, the cell selection assistance information 166 may include deployment information indicating at least one of standalone operation, in-band operation, and guard-band operation. Thus, for example, if in-band operation is indicated, then the user device should evaluate (e.g., one or more of: scan/detect, measure, evaluate/suitability check, connection establishment, etc.) in-band resources for cell selection. If, for example, guard-band is indicated, then the user device should evaluate (e.g., perform one or more of scan/detect, measure, evaluate/suitability check, connection establishment, etc.) guard-band resources for cell selection. Standalone operation may refer to where the user device/UE (e.g., IoT user device) may operate (e.g., send and receive signals or messages to a BS or other network device) even in the absence of a licensed 4G/5G/cellular network. In-band operation may refer to where the user device/UE (e.g., IoT user device) operates (e.g., sends and receives signals or messages with a BS or other network device) in the same band/using same resources as used by existing licensed wireless (4G/5G/LTE) network. Guard-band operation may refer to where the user device/UE (e.g., IoT user device) operates (e.g., sends and receives signals or messages to BS or other network device) using guard-band resources of an existing wireless (e.g., 4G/5G/LTE) network. For example, in the guard-band operation, no conflict would typically occur with existing 4G network because the UE/user device may, in an example implementation, use resources (e.g., to send or receive signals or messages) within a guard-band of an existing wireless network (e.g., within a guard band of an LTE network or other existing wireless network).

According to an example implementation, the cell selection assistance information 166 may include assistance information related to one or more of a band, a frequency, a carrier, a radio access technology (RAT), a cell, a tracking area, a location area, and a routing area. For example, a band and a specific subset of carrier frequencies may be identified, e.g., which may be set aside or may be used for exception reporting. Thus, with this information, the user device may first attempt to perform cell selection based on the cell selection assistance information 166, e.g., based on the specified deployment and/or via the specified resources (e.g., bands, carriers, frequencies, . . . ) as indicated by the assistance information, e.g., in order to decrease the amount of time that may be required for the user device to perform cell selection and send the exception report.

For example, various mobile network operators may reserve specific resources, e.g., bands, carriers, or other network resources, etc., for user devices to send exception reports to a cell. Also, in an example implementation, various service providers may purchase or lease specific resources to allow their customers to send high priority information, e.g., exception reports, to the service provider. For example, an alarm monitoring company may purchase a service from a mobile network operator and/or purchase or lease specific exception reporting resources (e.g., a specific subset of carriers for exception reporting) to allow their alarm monitoring customers to be able to quickly perform exception reporting for alarm conditions (e.g., fire, house break-in, or other alarm condition) to the alarm monitoring company. Such reserved resources may be used, for example, only by customers of the service provider/alarm monitoring company, and only for specific high priority communications, such as exception reporting, for example. These are merely some additional illustrative examples, and other examples may be used.

In one example implementation, the user device may use cell selection assistance information 166 to perform either normal reporting (normal operation) based on finding a cell that meets the first cell selection criteria 162, or exception reporting based on finding a cell that meets at least the second cell selection criteria 164. In another example implementation, the cell selection assistance information may only be used to select a cell for high priority/exception reporting, e.g., based on the second cell selection criteria for exception reporting.

According to an example implementation, if the cell selection assistance information 166 leads to selecting and then connecting to a cell that meets only the second cell selection criteria 164 for exception reporting to send an exception report, but such cell does not meet the first cell selection criteria 162 for normal operation/normal reporting, the user device may, for example, disconnect from such selected cell after sending the exception report, and then perform cell search again to find a cell that fulfills or meets the first cell selection criteria 162 for normal reporting/normal operation, for example, e.g., because the user device may not be allowed to camp on or perform normal operation/normal reporting with respect to a cell that does not meet/fulfill the first cell selection criteria 162, according to an example implementation.

Therefore, according to an example implementation, one or more of the following techniques may be used, in any combination, for exception reporting (i.e., high priority/emergency data transmission):

1) A second cell selection criteria 164 for exception reporting, which may be referred to as exception report specific cell selection criteria, S-Criteria, cell suitability criteria for exception reporting, is used by the user device to search for and find a cell for exception reporting. The second cell selection criteria 164 can be realized by defining a separate cell selection criteria for exception reporting as offset(s) (e.g., offsets from first cell selection criteria 162 for normal reporting) for the second cell selection criteria 164 for exception reporting. For example, if a first sell selection criteria 162 is defined with a first RSRQ threshold, then a negative offset for the RSRQ (offset from the first RSRQ threshold) may define the second cell selection criteria 164 with respect to the first cell selection criteria, e.g., which may be a second RSRQ threshold that is lower than/less than the first RSRQ threshold, for example. Also, separate first and second cell selection criteria may be provided for extended coverage (EC) conditions. As noted, the first cell selection criteria 162 for normal operation/normal reporting and the second cell selection criteria 164 may be based on the signal strength and/or quality, such as, e.g., RSRP, RSRQ, RSSI, CQI (channel quality indication), etc. The first and second cell selection criteria 162, 164, may be signaled via dedicated and/or broadcast signaling to the user device, for example. Optionally, the first and second cell selection criteria 162, 164 may be predefined in a wireless standard or wireless specification, for example. In an embodiment, the first and second cell selection criteria 162, 164 may differ in terms of one or more of a band, a frequency, a carrier, a radio access technology (RAT), a cell, a tracking area, a location area, and a routing area. For example, one or more carriers, RATs, cels, TAs, LAs, and/or RAs may be only allowed for exception reporting but not for normal reporting.

2) A network, via a cell or BS, may signal to the user device, cell assistance information 166 to indicate where or on what resources the cell search and exception reporting should be attempted by the user device, for example. Cell selection assistance information may be assistance information related to, e.g., a band, frequency, carrier, RAT (radio access technology), cell, Tracking Area, Location Area, Routing Area, where cell search should be performed and/or exception reporting should be attempted. The cell selection assistance information 166 may also include deployment information, e.g., which may indicate “standalone” operation, “in guard band operation” and “in-band operation.” The user device may or should search cells in cell selection using this cell selection assistance information. According to an example implementation, if no cells are found based on the cell selection assistance information 166, normal cell selection is started by the user device. While this cell selection assistance information 166 may typically be used only for cell search for exception reporting, according to another example implementation, the cell selection assistance information 166 may alternatively be used also for cell search for normal operation or normal reporting, for example. The cell selection assistance information 166 may be signaled, e.g., by the network via a cell or BS, via dedicated and/or broadcast signaling to the user device. In another example implementation of the second cell selection criteria 164 (e.g., where the second cell criteria 164 includes no criteria or thresholds), the user device may be allowed to ignore any cell selection criteria for the exception reporting. The user device may be allowed to fully or partly ignore any cell selection suitability criteria for the exception reporting. Optionally the user device may be allowed to select a cell from any PLMN. Any of these features or techniques described herein may be provided or implemented in any combination.

Table 1 describes an example cell selection for exception reporting according to an illustrative example implementation. In Table 1, procedures or operations are described for a number of example steps as part of an illustrative example. At step 1, a UE/user device is camping on a cell (e.g., camping on a guard band of band 1 of an NB-IoT cell), and has received and stored the following cell selection assistance information 166 via system information from the cell: bands 1 and 5, and “in guard band operation.” Also, the UE/user device is configured to operate in the extended DRX (eDRX cycle) of 4 hours and the UE/user device enters into a DRX sleep (low power) state.

At step 2, the UE/user device moves and is not within the coverage area of the same cell anymore.

At step 3, after 2 hours from receiving the previous paging report (or 2 hours since entering into a 4 hour DRX sleep state), the UE/user device wakes from DRX sleep state due to detecting/receiving an exception event or detecting/receiving an exception report (e.g., fire alarm report) that should be sent as soon as possible, e.g., within 10 seconds after detecting/receiving such exception event or exception report. Thus, for example, the exception event (e.g., fire alarm event in this example) caused the UE/user device to wake from its DRX sleep state to generate/send an exception report, e.g., due to the urgency of sending this exception report.

At step 4, the UE/user device begins performing cell selection based on the cell selection assistance information 166 (e.g., guard band from bands 1 and/or 5). In this illustrative example, the UE/user device scans various carriers/frequencies in band 1, but no cell is found. Then, the UE/user device then continues scanning carriers/frequencies from guard band of band 5, and a cell is detected from guard band of band 5, for example.

At step 5, the UE/user device receives system information from this cell, including first cell selection criteria 162 for normal reporting/normal operation and second cell selection criteria 164 for exception reporting (e.g., which may be indicated as an offset with respect to the first cell selection criteria 162, for example). Alternatively, the UE/user device may have received the first cell selection criteria 162 and/or second cell selection criteria 164 from another cell or BS, or this information may be stored by UE previously, e.g., as part of UE configuration. The UE/user device then compares the measured RSSI, RSRP, and/or RSRQ (or a value based on one or more of these) for the cell to the second cell selection criteria 164 to determine if the UE/user device may use this cell for exception reporting. The UE/user device may also compare the measured RSSI, RSRP, and/or RSRQ of the cell to the first cell selection criteria 162 to determine if the UE/user device may camp on this cell after sending the exception report. In this illustrative example, the signal(s) (e.g., RSSI, RSRP, and/or RSRQ) of the cell meets or fulfills the second cell selection criteria 164 for exception reporting, but does not meet the first cell selection criteria 162 for normal operation/normal reporting, for example.

According to an example implementation, the use of one or both of: the lower thresholds for the second cell selection criteria 164 for exception reporting (as compared to the higher signal thresholds for the first cell selection criteria 162 for normal operation/normal reporting) and/or the use of the cell selection assistance information 166 to search for a suitable cell for exception reporting may provide advantages of 1) making it more likely that the UE/user device will find a suitable cell (meeting at least the second cell selection criteria 164), and 2) that such cell will be found much quicker, e.g., to allow the UE/user device to more quickly find a cell and send the urgent (time sensitive) exception report, for example.

At step 6, the UE/user device establishes a connection to the cell, e.g., via a random access procedure or other procedure, for example. Thus, the UE/user device may be in a RRC_Connected state with respect to this cell.

At step 7, the UE/user device prepares and sends the exception report for the fire alarm event to the cell. After sending the exception report, the UE/user device then releases the connection from the cell and goes to Idle state (e.g., RRC_Idle).

At step 8, the UE/user device is not allowed to camp on this cell because the signals from the cell did not meet/fulfill the first cell selection criteria 162 for normal operation/normal reporting, and because there is no exception event/exception report available for reporting. Thus, the UE begins the cell selection procedure again to search for a new cell. In one example implementation, this additional cell selection procedure (to select a cell for normal operation or for camping) may be performed with the assistance of the cell selection assistance information 166. In another example implementation, because there is no pending exception report, this additional cell selection procedure may not be performed with the assistance of the cell selection assistance information 166 (e.g., in the case where cell selection assistance information is provided only to assist a UE with finding a cell for exception reporting, and not to find a cell for normal operation/camping).

TABLE 1
Example For Exception Reporting

| | | Message Sequence | |
|---|---|---|---|
| Step | Procedure | UE - NW | Message |
| 1 | The UE is camping on the NB-IoT cell | <− | System information |
| | (cell on the guard band of band 1) and has | | |
| | received and stored the following cell | | |
| | selection assistance information 166: | | |
| | 1. Bands 1 & 5 | | |
| | 2. “in guard band operation” | | |
| | The UE is configured with eDRX cycle of | | |
| | 4 hours and the UE is sleeping i.e. in DRX | | |
| 2 | The UE moves and is not on the coverage | — | |
| | area of the same cell any more. | | |
| 3 | After 2 hours from the previous paging | — | |
| | reception the exception report (e.g., fire | | |
| | alarm) becomes available for a | | |
| | transmission at the UE | | |
| 4 | The UE starts cell selection and scans (e.g., | — | |
| | based on cell selection assistance | | |
| | information 166) and tries to find a cell | | |
| | from guard band of band 1, but no cell is | | |
| | found. A cell is detected from guard band | | |
| | of band 5. | | |
| 5 | The UE reads system information which | <− | System information |
| | (in this illustrative example) may include | | |
| | first cell selection criteria 162 for normal | | |
| | operation/normal reporting and second cell | | |
| | selection criteria 164 for exception report. | | |
| | In this example, first cell selection criteria | | |
| | 162 for normal operation is not fulfilled, | | |
| | but second cell selection criteria 164 for | | |
| | exception reporting is fulfilled. | | |
| 6 | The UE starts/performs connection | <—> | Connection establishment |
| | establishment | | procedure is completed |
| 7 | The UE transmits Exception report and | <—> | Exception report |
| | RRC connection is released and the UE | | transmission |
| | goes to IDLE. | | |
| 8 | The UE is not allowed to camp on the same | | |
| | cell anymore, because the second cell | | |
| | selection criteria 164 for normal | | |
| | reporting/normal operation is not fulfilled | | |
| | and there is no exception report available | | |
| | for the transmission. The UE starts cell | | |
| | selection procedure. | | |

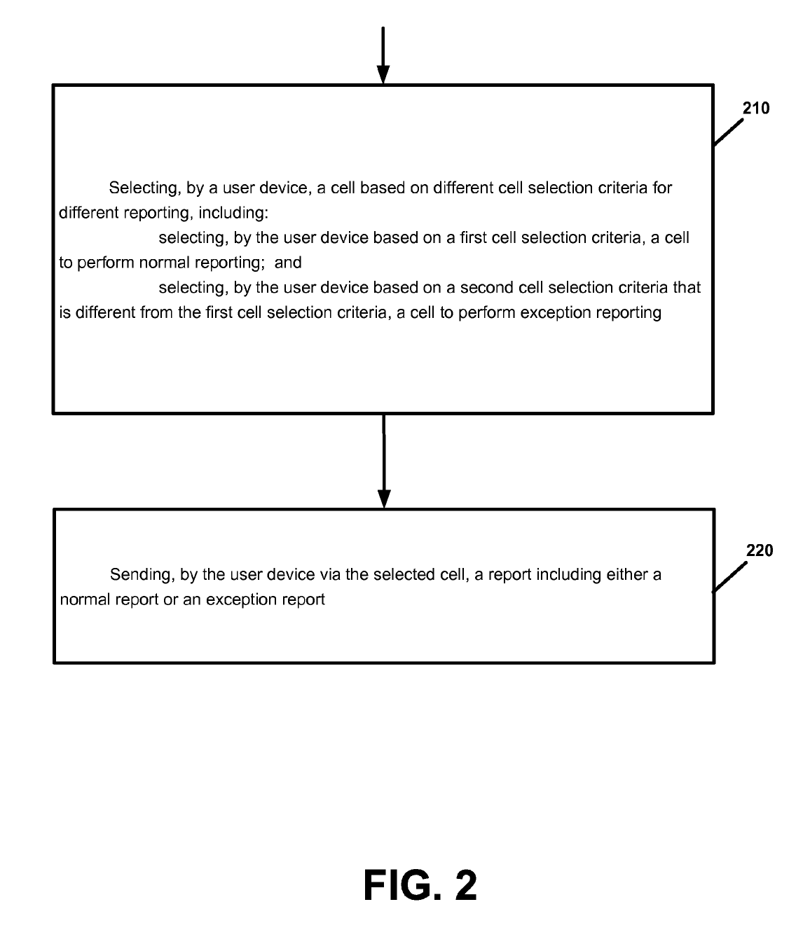

FIG. 2 is a flow chart illustrating operation of a user device according to an example implementation. The flow chart of the example shown in FIG. 2 describes a method of selecting a cell in a wireless network to send a report. Operation 210 includes selecting, by a user device, a cell based on different cell selection criteria for different reporting, including: selecting, by the user device based on a first cell selection criteria, a cell to perform normal reporting; and selecting, by the user device based on a second cell selection criteria that is different from the first cell selection criteria, a cell to perform exception reporting. Operation 220 includes sending, by the user device via the selected cell, a report including either a normal report or an exception report.

According to an example implementation of the method of FIG. 2, the method may further include determining, by the user device in the wireless network, the first cell selection criteria for normal reporting to report a normal event; determining, by the user device, the second cell selection criteria for exception reporting to report an exception event; and detecting, by the user device, an event, including either a normal event or an exception event, wherein an exception event is a higher priority than a normal event; and wherein the sending comprises sending, by the user device after selecting the cell, a report to report the detected event via the selected cell, the report including either a normal report to report a normal event or an exception report to report an exception event.

According to an example implementation of the method of FIG. 2, wherein the detecting an occurrence of an event comprises detecting an exception event; the selecting comprising selecting a cell based on the second cell selection criteria; and wherein sending the report comprises sending an exception report to report the exception event via the selected cell.

According to an example implementation of the method of FIG. 2, the method further including receiving, by the user device, cell selection assistance information to assist the user device with selecting a cell.

According to an example implementation of the method of FIG. 2, the method further including receiving, by the user device, cell selection assistance information to assist the user device with selecting a cell for exception reporting, wherein the cell selection assistance information comprises one or more of the following: one or more cells; one or more frequency bands; and one or more carrier frequencies.

According to an example implementation of the method of FIG. 2, the method further including receiving, by the user device, cell selection assistance information to assist the user device with selecting a cell for exception reporting, wherein the cell selection assistance information comprises one or more of the following: assistance information related to one or more of a band, a frequency, a carrier, a radio access technology (RAT), a cell, a tracking area, a location area, and a routing area; and deployment information indicating at least one of standalone operation, in-band operation, and guard-band operation.

According to an example implementation of the method of FIG. 2, the method further including receiving, by the user device, cell selection assistance information associated with selecting a cell for exception reporting; detecting an exception event; and wherein the selecting a cell comprises selecting, by the user device based on the second cell selection criteria and the cell selection assistance information, a cell to perform exception reporting; and wherein sending the report comprises sending an exception report to the selected cell to report the exception event.

According to an example implementation of the method of FIG. 2, wherein the first cell selection criteria or the second cell selection criteria includes: a value associated with a cell that is greater than a threshold, wherein the value is based on one or more of a received signal strength indication, a reference signal received power and a reference signal received quality for a signal received from the cell, wherein a first threshold is used for the first cell selection criteria and a second threshold, different from the first threshold, is used for the second cell selection criteria.

According to an example implementation of the method of FIG. 2, wherein the first threshold used for the first cell selection criteria is greater than the second threshold used for the second cell selection criteria, wherein the first cell selection criteria or the second cell selection criteria include at least one of the following: a received signal strength indication of a signal received from a cell that is greater than a threshold; a reference signal received power of a signal received from a cell that is greater than a threshold; and a reference signal received quality for a signal received from a cell that is greater than a threshold.

According to an example implementation of the method of FIG. 2, wherein the second cell selection criteria for exception event reporting includes no criteria that needs to be met before selecting a cell for transmitting an exception event report to report occurrence of an exception event.

According to an example implementation of the method of FIG. 2, the method further including detecting that a first cell fulfills the second cell selection criteria for exception reporting but not the first cell selection criteria for normal reporting; selecting the first cell to perform exception reporting; and establishing a connection with the selected first cell; wherein the sending comprises sending, by the user device to the selected cell, an exception report; and after sending the exception report to the selected cell, releasing the connection to the selected cell and searching for another cell that fulfills the first cell selection criteria.

According to an example implementation of the method of FIG. 2, wherein the determining the first cell selection criteria for normal reporting to report a normal event includes receiving, by a user device from a base station; the first cell selection criteria; and wherein the determining the second cell selection criteria for exception reporting to report an exception event includes receiving, by the user device from a base station, the second cell selection criteria.

According to an example implementation of the method of FIG. 2, wherein the determining the first cell selection criteria for normal reporting to report a normal event includes retrieving, by a user device from a memory of the user device, the first cell selection criteria that was previously stored in the memory; and wherein the determining the second cell selection criteria for exception reporting to report an exception event includes retrieving, by a user device from the memory of the user device, the second cell selection criteria that was previously stored in the memory.

According to an example implementation, a computer program product, includes a computer-readable storage medium and storing executable code that, when executed by at least one data processing apparatus, is configured to cause the at least one data processing apparatus to perform a method of: selecting, by a user device, a cell based on different cell selection criteria for different reporting, including: selecting, by the user device based on a first cell selection criteria, a cell to perform normal reporting; and selecting, by the user device based on a second cell selection criteria that is different from the first cell selection criteria, a cell to perform exception reporting; and sending, by the user device via the selected cell, a report including either a normal report or an exception report.

An apparatus comprising at least one processor and at least one memory including computer instructions, when executed by the at least one processor, cause the apparatus to: select, by a user device, a cell based on different cell selection criteria for different reporting, including causing the apparatus to: select, by the user device based on a first cell selection criteria, a cell to perform normal reporting; and select, by the user device based on a second cell selection criteria that is different from the first cell selection criteria, a cell to perform exception reporting; and send, by the user device via the selected cell, a report including either a normal report or an exception report.

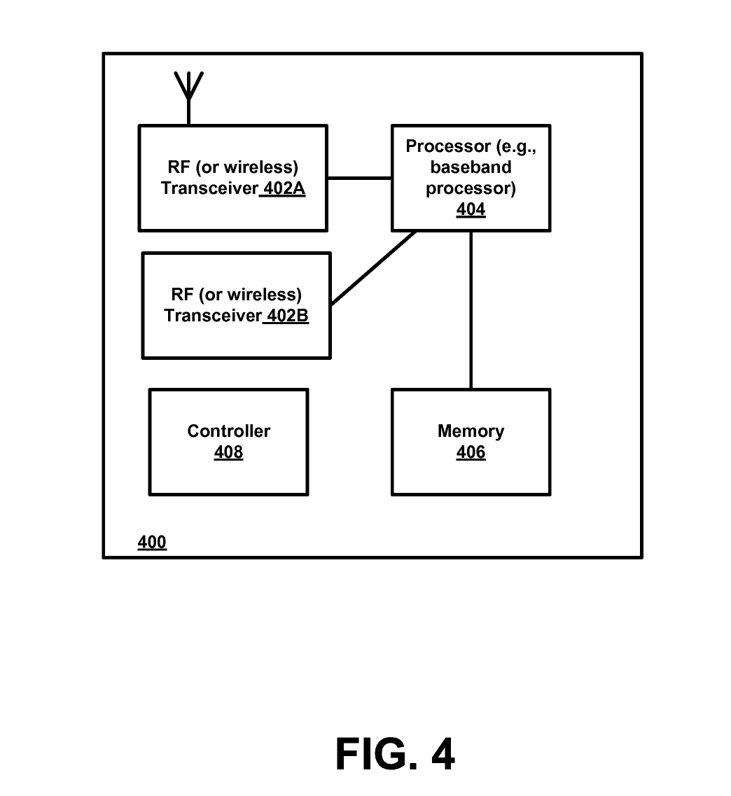

According to an example implementation, an apparatus may include: means (e.g., 402A/402B, 404, FIG. 4) for selecting, by a user device, a cell based on different cell selection criteria for different reporting, including: means (e.g., 402A/402B, 404, FIG. 4) for selecting, by the user device based on a first cell selection criteria, a cell to perform normal reporting; and means (e.g., 402A/402B, 404, FIG. 4) for selecting, by the user device based on a second cell selection criteria that is different from the first cell selection criteria, a cell to perform exception reporting; and means (e.g., 402A/402B, 404, FIG. 4) for sending, by the user device via the selected cell, a report including either a normal report or an exception report.

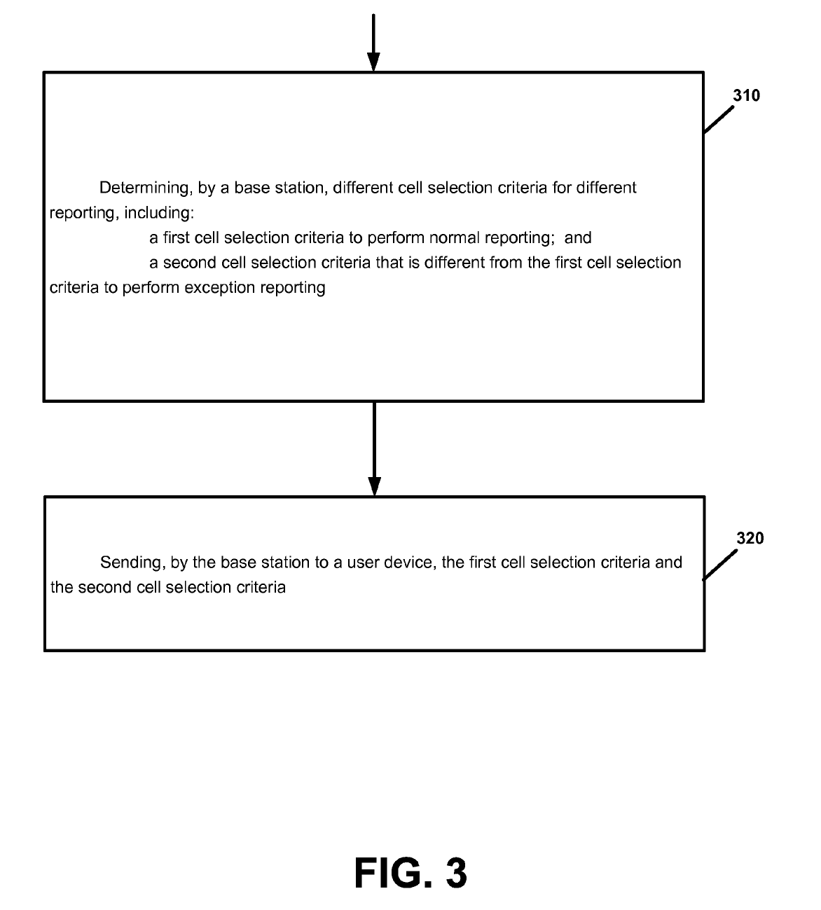

FIG. 3 is a flow chart illustrating operation of a base station (or other network device) according to an example implementation. Operation 310 includes determining, by a base station, different cell selection criteria for different reporting, including: a first cell selection criteria to perform normal reporting; and a second cell selection criteria that is different from the first cell selection criteria to perform exception reporting. And, operation 320 includes sending, by the base station to a user device, the first cell selection criteria and the second cell selection criteria.

According to an example implementation of the method of FIG. 3, the sending may include: sending, by the base station to the user device: the first cell selection criteria; and a second cell selection criteria-offset that indicates the second cell selection criteria as one or more offsets from the first cell selection criteria.

According to an example implementation of the method of FIG. 3, the sending may include receiving, by the base station, a report including either a normal report or an exception report.

According to an example implementation of the method of FIG. 3, the sending may further include sending, by the base station to the user device, cell selection assistance information to assist the user device with selecting a cell.

According to an example implementation of the method of FIG. 3, the sending may further include sending, by the base station to the user device, cell selection assistance information to assist the user device with selecting a cell for exception reporting, wherein the cell selection assistance information comprises information identifying one or more of the following: one or more cells; one or more frequency bands; and one or more carrier frequencies.

According to an example implementation of the method of FIG. 3, the sending may further include sending, by the base station to the user device, cell selection assistance information to assist the user device with selecting a cell for exception reporting, wherein the cell selection assistance information comprises one or more of the following: assistance information related to one or more of a band, a frequency, a carrier, a radio access technology (RAT), a cell, a tracking area, a location area, and a routing area; and deployment information indicating at least one of standalone operation, in-band operation, and guard-band operation.

According to an example implementation of the method of FIG. 3, wherein the first cell selection criteria or the second cell selection criteria may include: a value associated with a cell that is greater than a threshold, wherein the value is based on one or more of a received signal strength indication, a reference signal received power and a reference signal received quality for a signal received from the cell, wherein a first threshold is used for the first cell selection criteria and a second threshold, different from the first threshold, is used for the second cell selection criteria.

According to an example implementation of the method of FIG. 3, wherein the first threshold used for the first cell selection criteria is greater than the second threshold used for the second cell selection criteria.

According to an example implementation of the method of FIG. 3, wherein the first cell selection criteria or the second cell selection criteria may include at least one of the following: a received signal strength indication of a signal received from a cell that is greater than a threshold; a reference signal received power of a signal received from a cell that is greater than a threshold; and a reference signal received quality for a signal received from a cell that is greater than a threshold.

According to an example implementation of the method of FIG. 3, wherein the second cell selection criteria for exception event reporting includes no criteria that needs to be met before selecting a cell for transmitting an exception report to report an exception event.

A computer program product, the computer program product comprising a computer-readable storage medium and storing executable code that, when executed by at least one data processing apparatus, is configured to cause the at least one data processing apparatus to perform a method of: determining, by a base station, different cell selection criteria for different reporting, including: a first cell selection criteria to perform normal reporting; and a second cell selection criteria that is different from the first cell selection criteria to perform exception reporting; and sending, by the base station to a user device, the first cell selection criteria and the second cell selection criteria.

An apparatus including at least one processor and at least one memory including computer instructions, when executed by the at least one processor, cause the apparatus to perform the method of: determining, by a base station, different cell selection criteria for different reporting, including: a first cell selection criteria to perform normal reporting; and a second cell selection criteria that is different from the first cell selection criteria to perform exception reporting; and sending, by the base station to a user device, the first cell selection criteria and the second cell selection criteria.

An apparatus including: means (e.g., 402A/402B, 404, FIG. 4) for determining, by a base station, different cell selection criteria for different reporting, including: means (e.g., 402A/402B, 404, FIG. 4) for determining a first cell selection criteria to perform normal reporting; and means (e.g., 402A/402B, 404, FIG. 4) for determining a second cell selection criteria that is different from the first cell selection criteria to perform exception reporting; and means (e.g., 402A/402B, 404, FIG. 4) for sending, by the base station to a user device, the first cell selection criteria and the second cell selection criteria.

FIG. 4 is a block diagram of a wireless station (e.g., AP or user device) 400 according to an example implementation. The wireless station 400 may include, for example, one or two RF (radio frequency) or wireless transceivers 402A, 402B, where each wireless transceiver includes a transmitter to transmit signals and a receiver to receive signals. The wireless station also includes a processor or control unit/entity (controller) 404 to execute instructions or software and control transmission and receptions of signals, and a memory 406 to store data and/or instructions.

Processor 404 may also make decisions or determinations, generate frames, packets or messages for transmission, decode received frames or messages for further processing, and other tasks or functions described herein. Processor 404, which may be a baseband processor, for example, may generate messages, packets, frames or other signals for transmission via wireless transceiver 402 (402A or 402B). Processor 404 may control transmission of signals or messages over a wireless network, and may control the reception of signals or messages, etc., via a wireless network (e.g., after being down-converted by wireless transceiver 402, for example). Processor 404 may be programmable and capable of executing software or other instructions stored in memory or on other computer media to perform the various tasks and functions described above, such as one or more of the tasks or methods described above. Processor 404 may be (or may include), for example, hardware, programmable logic, a programmable processor that executes software or firmware, and/or any combination of these. Using other terminology, processor 404 and transceiver 402 together may be considered as a wireless transmitter/receiver system, for example.

In addition, referring to FIG. 4, a controller (or processor) 408 may execute software and instructions, and may provide overall control for the station 400, and may provide control for other systems not shown in FIG. 4, such as controlling input/output devices (e.g., display, keypad), and/or may execute software for one or more applications that may be provided on wireless station 400, such as, for example, an email program, audio/video applications, a word processor, a Voice over IP application, or other application or software.

In addition, a storage medium may be provided that includes stored instructions, which when executed by a controller or processor may result in the processor 404, or other controller or processor, performing one or more of the functions or tasks described above.

According to another example implementation, RF or wireless transceiver(s) 402A/402B may receive signals or data and/or transmit or send signals or data. Processor 404 (and possibly transceivers 402A/402B) may control the RF or wireless transceiver 402A or 402B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (TOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-29. (canceled)

30. A method comprising:
receiving, by a user device from a base station, a cell selection assistance information, wherein the cell selection assistance information includes at least deployment information indicating at least one of standalone operation, in-band operation and guard-band operation; and
using, by the user device, the cell selection assistance information.

31. The method of claim 30, wherein the using comprises:
performing, by the user device, a cell selection or cell reselection based on the cell selection assistance information.

32. The method of claim 31 wherein performing cell selection or cell reselection comprises at least one of the following:
evaluating resources, in the absence of a licensed wireless network, for the purpose of cell selection if the deployment information indicates standalone operation;
evaluating in-band resources, which are the same as resources used by an existing licensed wireless network, for the purpose of cell selection if the deployment information indicates in-band operation; and
evaluating guard-band resources, which are guard-band resources of an existing licensed wireless network, for the purpose of cell selection if the deployment information indicates guard-band operation.

33. The method of claim 31 wherein the using comprises:
determining resources to be evaluated based on the deployment information indicating at least one of standalone operation, in-band operation and guard-band operation;
evaluating the determined resources; and
performing cell selection or cell reselection based on the evaluating of the determined resources.

34. The method of claim 31, and further comprising:
establishing, by the user device, a connection to a cell that is selected as part of the cell selection or cell reselection.

35. The method of claim 31 wherein the cell selection assistance information comprises additional cell selection assistance information related to one or more of a band, a frequency, a carrier, a radio access technology (RAT), a cell, a tracking area, a location area, and a routing area.

36. The method of claim 35 wherein the performing, by the user device, a cell selection or cell reselection comprises:
performing, by the user device, a cell selection or cell reselection based on the deployment information and the additional cell selection assistance information.

37. The method of claim 35 wherein the performing, by the user device, a cell selection comprises:
performing, by the user device, a cell selection or cell reselection within or for a frequency, a carrier, a radio access technology (RAT), a cell, a tracking area, a location area, or a routing area, as indicated by the additional cell selection assistance information, and within a band indicated by the deployment information.

38. The method of claim 35 wherein the performing, by the user device, a cell selection comprises:
performing, by the user device, a cell selection or cell reselection within a frequency or carrier, as indicated by the additional cell selection assistance information, and within a band indicated by the deployment information.

39. An apparatus comprising at least one processor and at least one memory including computer instructions, when executed by the at least one processor, cause the apparatus to:
receive, by a user device from a base station, a cell selection assistance information, wherein the cell selection assistance information includes at least deployment information indicating at least one of standalone operation, in-band operation and guard-band operation; and
use, by the user device, the cell selection assistance information.

40. The apparatus of claim 39, wherein causing the apparatus to use comprises causing the apparatus to:
perform, by the user device, a cell selection or cell reselection based on the cell selection assistance information.

41. The apparatus of claim 40 wherein causing the apparatus to perform cell selection or cell reselection comprises causing the apparatus to perform at least one of the following:
evaluate resources, in the absence of a licensed wireless network, for the purpose of cell selection if the deployment information indicates standalone operation;
evaluate in-band resources, which are the same as resources used by an existing licensed wireless network, for the purpose of cell selection if the deployment information indicates in-band operation; and
evaluate guard-band resources, which are guard-band resources of an existing licensed wireless network, for the purpose of cell selection if the deployment information indicates guard-band operation.

42. The apparatus of claim 40 and further causing the apparatus to:
establish, by the user device, a connection to a cell that is selected as part of the cell selection or reselection.

43. The apparatus of claim 40 wherein the cell selection assistance information comprises additional cell selection assistance information related to one or more of a band, a frequency, a carrier, a radio access technology (RAT), a cell, a tracking area, a location area, and a routing area.

44. The apparatus of claim 43 wherein causing the apparatus to perform, by the user device, a cell selection or cell reselection comprises causing the apparatus to:
perform, by the user device, a cell selection based on the deployment information and the additional cell selection assistance information.

45. The apparatus of claim 43 wherein causing the apparatus to perform, by the user device, a cell selection or cell reselection comprises causing the apparatus to:
perform, by the user device, a cell selection or cell reselection within a frequency or carrier, as indicated by the additional cell selection assistance information, and within a band indicated by the deployment information.

46. A method comprising:
determining, by a base station, a cell selection assistance information, wherein the cell selection assistance information includes at least deployment information indicating at least one of standalone operation, in-band operation and guard-band operation; and
sending, by the base station to the user device, the cell selection assistance information to assist a user device with selecting a cell.

47. The method of claim 46 wherein the sending comprises:
sending, by the base station via broadcast information to the user device, the cell selection assistance information to assist the user device with selecting a cell.

48. The method of claim 46 wherein the cell selection assistance information comprises additional cell selection assistance information related to one or more of a band, a frequency, a carrier, a radio access technology (RAT), a cell, a tracking area, a location area, and a routing area.

49. An apparatus comprising at least one processor and at least one memory including computer instructions, when executed by the at least one processor, cause the apparatus to:
determine, by a base station, a cell selection assistance information, wherein the cell selection assistance information includes at least deployment information indicating at least one of standalone operation, in-band operation and guard-band operation; and
send, by the base station to the user device, the cell selection assistance information to assist a user device with selecting a cell.

50. The apparatus of claim 49 wherein causing the apparatus to send comprises causing the apparatus to:
send, by the base station via broadcast information to the user device, the cell selection assistance information to assist the user device with selecting a cell.

51. The apparatus of claim 49 wherein the cell selection assistance information comprises additional cell selection assistance information related to one or more of a band, a frequency, a carrier, a radio access technology (RAT), a cell, a tracking area, a location area, and a routing area.
